(19) United States
(12) Patent Application Publication
(10) Pub. No.: US 2025/0138212 A1
(43) Pub. Date: May 1, 2025

(54) IMPLICIT STRUCTURAL MODELING USING TREE DATA STRUCTURES

(71) Applicant: Schlumberger Technology Corporation, Sugar Land, TX (US)

(72) Inventor: Julien Renaudeau, Lysaker (NO)

(21) Appl. No.: 18/833,676

(22) PCT Filed: Mar. 22, 2023
(86) PCT No.: PCT/US2023/015906

§ 371 Date: Jul. 26, 2024

Related U.S. Application Data
(60) Provisional application No. 63/269,856, filed on Mar. 24, 2022.

(51) Int. Cl. G01V 1/34; G06T 17/00; G06T 17/20

(52) U.S. Cl. CPC G01V 1/345; G06T 17/005; G06T 17/20

(57) ABSTRACT

A method includes receiving data representing a subsurface volume, the data including data points representing one or more physical properties of the subsurface volume, generating a tree data structure representing the subsurface volume, including partitioning a digital representation of the subsurface volume into mesh elements based at least in part on locations of the data points, storing a location of the mesh elements in the tree data structure, and assigning coefficients to the mesh elements, the coefficients representing one or more physical properties of the subsurface volume represented by the individual mesh elements. The method also includes determining an implicit function representing the one or more physical properties of the subsurface volume based at least in part on the assigned coefficients, the implicit function being continuous across a domain, and visualizing at least a portion of the subsurface volume based at least in part on the implicit function.

### CROSS-REFERENCE TO RELATED APPLICATIONS

This application claims priority to U.S. Provisional Patent Application No. 63/269,856, which was filed on Mar. 24, 2022 and is incorporated herein by reference in its entirety.

### BACKGROUND

Structural modeling is used to model and simulate properties in various different environments and contexts. For example, oilfield exploration and production make use of such models. In such applications, the properties of the subsurface volumes may be measured in some locations, but there may be areas, e.g., between wells, with unknown characteristics. Seismic data may be employed to infer the properties in these areas; however, processing seismic data relies on the accurately modeling the geology and lithology of the subsurface. Once constructed, accurate models of the subsurface may permit fluid flow simulations and other property simulations to be conducted, which may in turn guide and assist well planning, drilling, completion, and/or production efforts.

Implicit structural modeling is a specific class of algorithms that represent the subsurface and its geological units with a volumetric function. Implicit structural modeling includes identifying an implicit function for the property being modeled. The implicit function fits data constraints, interpolates in between, and extrapolates the information following predefined assumptions (e.g., a smooth regularization). This function is constructed on a numerical support that can be a regular mesh (e.g., Cartesian grid), an irregular mesh (e.g., tetrahedral mesh), or the data itself (i.e., nodal support).

Depending on the chosen support and its constraints, some compatible continuous interpolation functions (i.e., “shape functions”) may be constructed. For example, the Finite Element Method (FEM) includes constructing functions on grids and meshes, and meshless/mesh-reduction functions can be constructed on sampled point clouds and data points (e.g., Moving Least Squares, Radial Basis Functions, Extended Finite Element Method functions).

Several types of implicit structural modeling are available and employed with varying success. For example, Discrete Smooth Interpolation (DSI) may be employed using FEM functions on mesh elements (e.g., triangles or tetrahedra). Another type of implicit structural modeling is the Potential Field Method (PFM). This class of algorithm uses dual co-kriging on stratigraphic data points to contrasted the implicit function. Efforts have also been made to generate interpolation functions on regular supports such as the Cartesian grid.

These structural implicit modeling techniques can be a challenge to implement, especially in the context of the subsurface, where discontinuities are often present. For example, in DSI and VBM, the triangle or tetrahedral mesh is difficult to confirm to the structural discontinuities, and interpolation with a unit volume is linear. Accordingly, the scalability of this approach may depend on the mesh generator's efficiency and stability. Challenges with PFM include solving the system in humanly-realistic time periods. Cartesian methods may likewise have processing-time constraints, especially in large volumes where, to model the discontinuities, the grid is defined with relatively small elements in comparison to a relatively large volume being modeled, leading to a large number of coefficients to solve.

### SUMMARY

Embodiments of the disclosure include a method including receiving data representing a subsurface volume, the data including data points representing one or more physical properties of the subsurface volume, generating a tree data structure representing the subsurface volume, generating the tree data structure includes partitioning a digital representation of the subsurface volume into mesh elements based at least in part on locations of the data points of the data, storing a location of the mesh elements in the tree data structure, and assigning coefficients to the mesh elements, the coefficients representing one or more physical properties of the subsurface volume represented by the individual mesh elements. The method also includes determining an implicit function representing the one or more physical properties of the subsurface volume based at least in part on the assigned coefficients, the implicit function being continuous across a domain; and visualizing at least a portion of the subsurface volume based at least in part on the implicit function.

In an embodiment, the method includes separating the digital representation of the subsurface volume into two domains, including the domain, based at least in part on a presence of a structural discontinuity in the subsurface, and determining the implicit function separately for the two domains, the implicit function is continuous in the respective domains.

In an embodiment, the method includes identifying a first mesh element of the mesh elements having a first size, identifying a second mesh element of the mesh elements that shares at least a portion of an edge with the first mesh element, the second mesh element having a second size that is smaller than the first size, and substituting the coefficient of the second mesh element by interpolating the assigned coefficients of two mesh elements that neighbor the second mesh element.

In an embodiment, the first size and the second size are represented by two different depths of two tree elements in the tree data structure, the two tree elements representing the first mesh element and the second mesh element, respectively, in the tree data structure.

In an embodiment, partitioning includes constraining neighboring mesh elements to a maximum of one level of the depth difference in the tree data structure.

In an embodiment, the tree data structure includes at least one of a binary tree, a quadtree, or an octree.

In an embodiment, assigning the coefficients comprises applying a Heaviside step function, a finite element method, or a gradient function based on a center of the individual mesh elements.

In an embodiment, the method includes simulating the one or more properties of the subsurface volume over time using the implicit function.

Embodiments of the disclosure also include a non-transitory, computer-readable medium storing instructions that, when executed by at least one processor of a computing system, cause the computing system to perform operations. The operations include receiving data representing a subsurface volume, the data including data points representing one or more physical properties of the subsurface volume, generating a tree data structure representing the subsurface volume, generating the tree data structure includes partitioning a digital representation of the subsurface volume into mesh elements based at least in part on locations of the data points of the data, storing a location of the mesh elements in the tree data structure, and assigning coefficients to the mesh elements, the coefficients representing one or more physical properties of the subsurface volume represented by the individual mesh elements. The operations also include determining an implicit function representing the one or more physical properties of the subsurface volume based at least in part on the assigned coefficients, the implicit function being continuous across a domain, and visualizing at least a portion of the subsurface volume based at least in part on the implicit function.

Embodiments of the disclosure also include a computing system that includes one or more processors, and a memory system comprising one or more non-transitory computer-readable media storing instructions that, when executed by at least one of the one or more processors, cause the computing system to perform operations. The operations include receiving data representing a subsurface volume, the data including data points representing one or more physical properties of the subsurface volume, generating a tree data structure representing the subsurface volume, generating the tree data structure includes partitioning a digital representation of the subsurface volume into mesh elements based at least in part on locations of the data points of the data, storing a location of the mesh elements in the tree data structure, and assigning coefficients to the mesh elements, the coefficients representing one or more physical properties of the subsurface volume represented by the individual mesh elements. The operations also include determining an implicit function representing the one or more physical properties of the subsurface volume based at least in part on the assigned coefficients, the implicit function being continuous across a domain, and visualizing at least a portion of the subsurface volume based at least in part on the implicit function.

Thus, the computing systems and methods disclosed herein are more effective methods for processing collected data that may, for example, correspond to a surface and a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a flowchart of a method for implicitly modeling a subsurface, according to an embodiment.

FIG. 5 illustrates a conceptual, two-dimensional view of a subsurface volume, according to an embodiment.

FIG. 6 illustrates a schematic view of a tree data structure, according to an embodiment.

FIG. 7A illustrates another conceptual, two-dimensional view of the subsurface volume, according to an embodiment.

FIG. 7B illustrates another conceptual, two-dimensional view of the subsurface volume, including a discontinuity, according to an embodiment.

FIG. 8A illustrates another conceptual, two-dimensional view of the subsurface volume, showing a substitution phase, according to an embodiment.

FIG. 8B illustrates another conceptual, two-dimensional view of the subsurface volume, showing the completion of the substitution phase, according to an embodiment.

FIG. 9 illustrates a conceptual visualization of a subsurface volume including a discontinuity and nodes, including both original and substituted corners, according to an embodiment.

FIG. 10 illustrates a visualization of the implicit model, according to an embodiment.

FIG. 11 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention, according to an embodiment. However, it will be apparent to one of ordinary skill in the art that the invention, according to an embodiment, may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the embodiments of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if”' may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed. Although the following description focuses on oilfield technology, it will be readily appreciated that embodiments of the systems and methods described herein may be used in any context to model a subsurface domain, e.g., in other energy sectors such as solar, wind, and geothermal, as well as potentially any surface or subterranean construction projects.

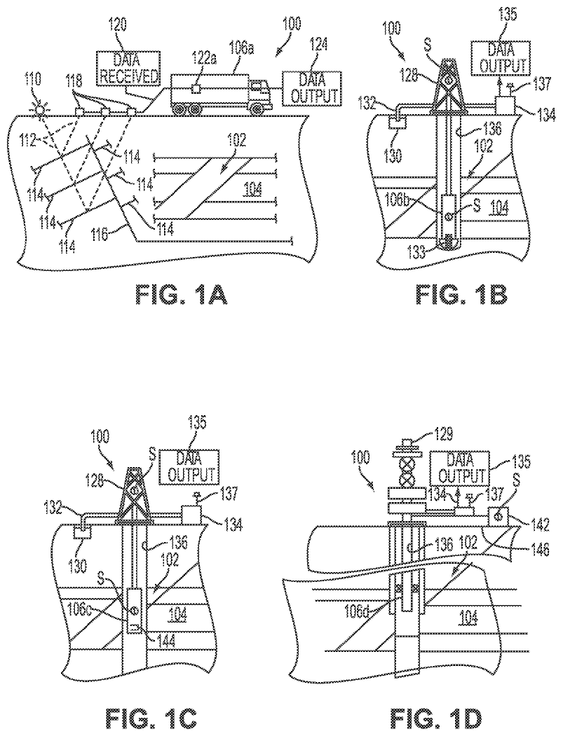

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time or stored for later use. The data may also be combined with historical data or other inputs for further analysis. The data may be stored in separate databases or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

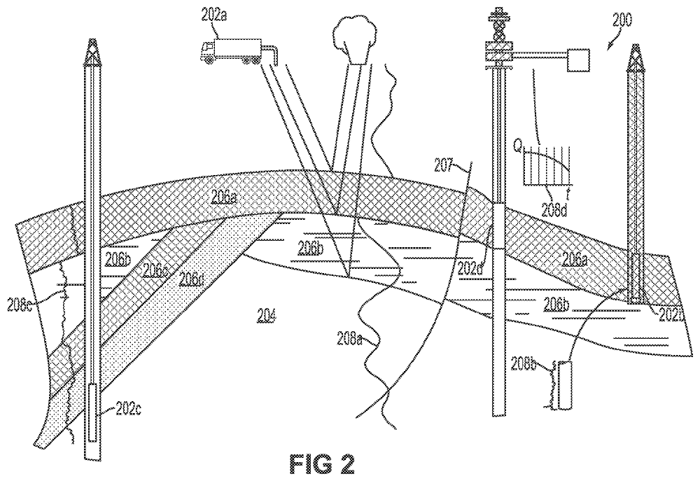

FIG. 4 illustrates a flowchart of a method 400 for generating an implicit model of a subsurface volume, according to an embodiment. As noted above, the implicit model may be employed for visualization, e.g., to display the model on a display device. Moreover, such models may be “simulated”, e.g., used to model fluid flow, etc., over time in the subsurface volume, potentially in different scenarios. Such visualizations and simulations may assist operators in making decisions related to parameters for operations (e.g., exploration, drilling, construction). A variety of other practical applications will be readily understood by one of ordinary skill in the art.

In the illustrated embodiment, the method 400 includes receiving data (e.g., interpreted data) representing the subsurface volume, as at 402. For example, the data may include data collected from a well, such as well logs, which may have a relatively high resolution. The data may also include seismic data and/or other data, e.g., away from the well, which may have relatively low resolution. Accordingly, the data may include data points at various locations in the subsurface, and the data points may be unequally distributed, e.g., data points more densely populated in the areas near the wells. The data may also reveal structures in the subsurface, such as faults or other discontinuities, horizons, etc.

The method 400 may also include generating a tree data structure to represent the subsurface volume, as at 404. The tree data structure may include tree elements, with the individual elements representing discrete portions (e.g., nodes, cells, triangles, etc., generally referred to herein as “mesh elements”) within the subsurface volume. The tree elements may, for example, store a location, e.g., the location of one or more mesh element locations (e.g., centers or corners) in a Cartesian grid. A size may also be associated with the tree elements, e.g., a size of the mesh element (e.g., area, volume, node spacing, etc.). The size may be based on a depth of the tree element in the tree (depth refers to the number of elements between the root of the tree and a given element). Accordingly, each tree element may represent a discrete portion in the subsurface, identified conceptually herein as a mesh element. In some cases, the tree may have a predefined structure, such as a binary tree, quadtree, octree, etc. The type of tree may define how many child elements stem from individual parent elements. The individual mesh elements may represent an “unknown”, e.g., a coefficient of an implicit function, which may be solved using a variety of techniques. The coefficient may be determined by one or more physical properties of the subsurface in the mesh element, which may determine how the subsurface represented thereby behaves in a simulation. Within individual mesh elements, a property function may be assigned or otherwise established, such as a Heaviside step function, finite element method functions, a constant, or gradient.

The mesh elements may be assigned based at least in part on the location of the data points, e.g., the density of the data points in a given area or volume. For example, a maximum number of data points to be contained within a given mesh element may be set (e.g., predefined, user-selected, etc.). The method 400 may then subdivide individual mesh elements, potentially several times, until an individual mesh element (represented by a tree element of the tree data structure) includes the maximum number of data points or fewer. The tree data structure may not be symmetrical, as tree elements representing mesh elements that are in areas of dense data point distribution may represent smaller areas (e.g., may be deeper in the tree) than tree elements representing mesh elements that are in areas with less densely distributed data points.

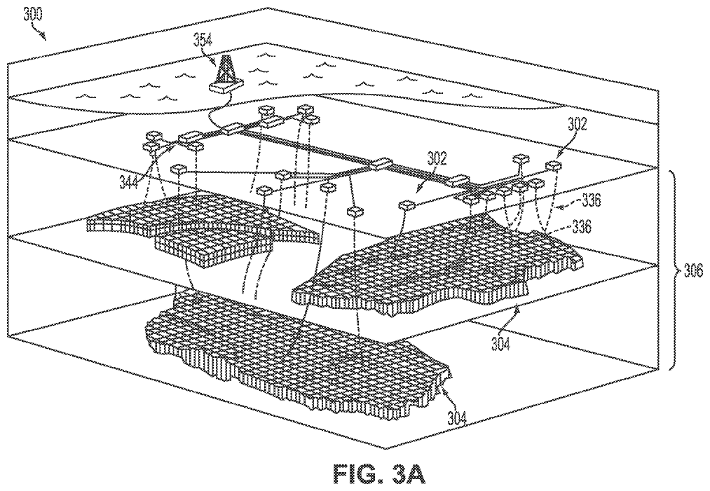

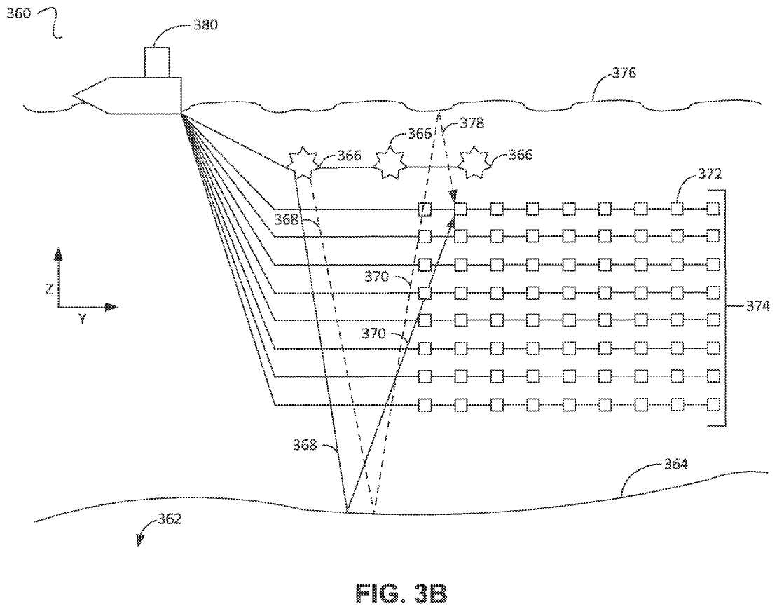

FIG. 5 illustrates a simplified, two-dimensional view of a subsurface volume 500, according to an embodiment. As shown, the volume 500 is divided into differently-sized mesh elements, which are rectangles in this embodiment. Such partitioning is accomplished using a tree data structure, in this case, a quadtree. FIG. 6 illustrates a simplified view of a tree data structure 600 which may be used to represent the volume 500, according to an embodiment. As shown in FIG. 6, the tree data structure 600 has four levels (e.g., depths), a first or “root” element 602 is in the first level. The illustrated tree data structure is a quadtree, and thus four-way partitioning of the root element 602 yields four second-level elements 604. Partitioning the second-level elements 604 yields third-level elements 606, partitioning the third-level elements yields fourth-level elements 608, and so on. At each successive level of partitioning, the size of the mesh element (e.g., spacing between nodes) represented by the elements is smaller. Accordingly, referring again additionally to FIG. 5, the second-level elements 604 represent the mesh elements labeled as ‘2’, the third-level elements 606 represent the mesh elements labeled as ‘3’, and the fourth-level elements represent the mesh elements labeled as ‘4’. It will be appreciated that any number of levels of mesh (and thus tree) elements may be employed, with the illustrated four levels merely being a simple illustration. Further, it will be appreciated that a three-dimensional volume may also be represented, with the partitioning expanded to three-dimensions, using any partitioning regime (e.g., octree).

As shown in FIG. 5, the subsurface volume includes data points 502. The partitioning of the mesh elements may proceed until a certain maximum number of data points 502, or fewer, are within the individual mesh elements. In the simple illustration of FIG. 5, the maximum is one data point 502. Thus, for example, in the middle-right column, second row down, two of the data points 502-1, 502-2 are relatively close together; thus, the partitioning reached the fourth level in this area, in order to meet the criteria of one data point 502 per mesh element.

Various constraints may be placed on the partitioning process, in addition to the number of child mesh elements that are created by partitioning a given parent mesh element. For example, in some embodiments, adjacent mesh elements may be represented by tree elements at a maximum of one different depth level. Further, in some embodiments, the direction of division for partitioning corresponds to a mesh element's largest dimension.

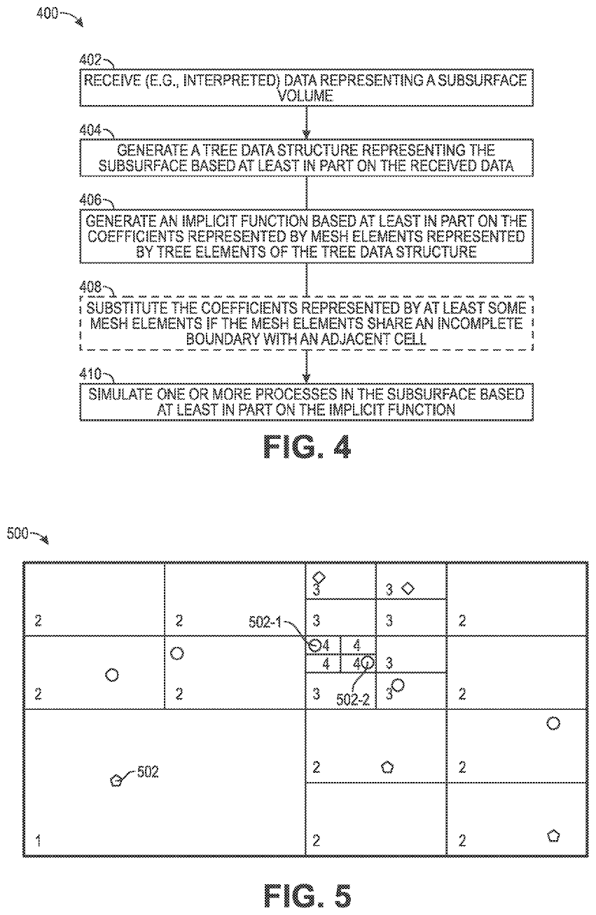

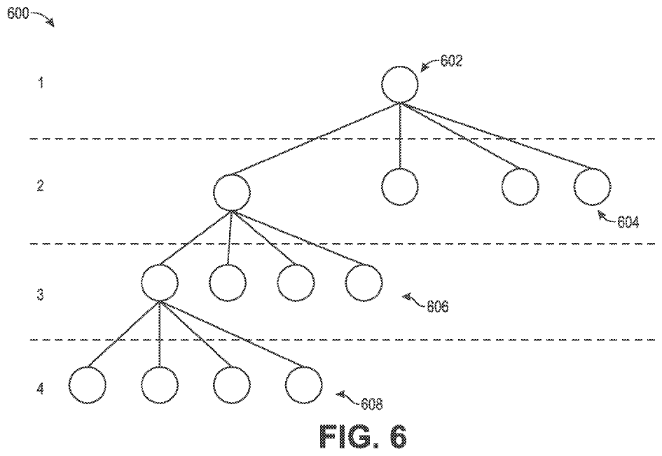

FIG. 7A illustrates another simplified, two-dimensional view of the subsurface volume 500. In this embodiment, the volume 500 is represented by mesh elements having centers 700, which represent the coefficients of the mesh elements. The coefficients are the “unknowns” of the implicit model. These unknowns may be solved as part of the implicit function, and may be constrained by the input data points 502, so that the model behaves consistently with the information that is known (i.e., the data points). The unknowns may be at the centers, as shown, or in the corners, with interpolation being used to define a gradient (or another relationship) within the given mesh elements, to proceed between the corners, edges, or in any other manner.

The method 400 may then proceed to generating an implicit function based at least in part on the coefficients, as at 406. The implicit function may be continuous for a given domain of the subsurface. The subsurface may have several domains, however, which may be separated by a discontinuity, e.g., a fault. Because the properties of the subsurface may not be continuous across the discontinuity, to accurately model its behavior, the modeling function is also not continuous. However, the implicit function is continuous; thus, to handle the presence of discontinuities, the discontinuities may be treated as boundaries between domains. The implicit functions may thus be continuous within the domains. In other embodiments, the discontinuities may be handled using ghost elements (e.g., nodes), with an extended FEM being used to discard the mesh elements that represent the discontinuity. FIG. 7B illustrates a view similar to FIG. 7A, but also showing a discontinuity 750 (e.g., fault) that may be represented.

Referring again to FIG. 4, the method 400 may proceed to a substitution phase. For example, the method 400 may include substituting the contents of the mesh elements (e.g., coefficients, functions, etc.) represented by at least some of the mesh elements based on the at least some of the mesh elements sharing an incomplete boundary with an adjacent mesh element, as at 408. In other words, if a corner in a quadtree embodiment is shared by fewer than four mesh elements, then the node is on the corner of a mesh element bordered by a larger mesh element. This smaller mesh element may thus be interpolated based on its neighbors, e.g., to avoid discontinuities in the implicit function based on two or more mesh elements sharing a single edge with a neighboring mesh element. Such substitution may also reduce computing time by reducing the number of mesh elements, and thus computations, for a simulation. The smaller mesh element may be interpolated, e.g., based on a linear combination (e.g., average) of its neighbors.

It will be appreciated that, in some embodiments, incomplete boundaries may be avoided and/or substitution may be replaced with other techniques (e.g., mean value) configured to avoid discontinuities in the implicit function. Thus, it is emphasized that this workstep may be omitted in at least some embodiments.

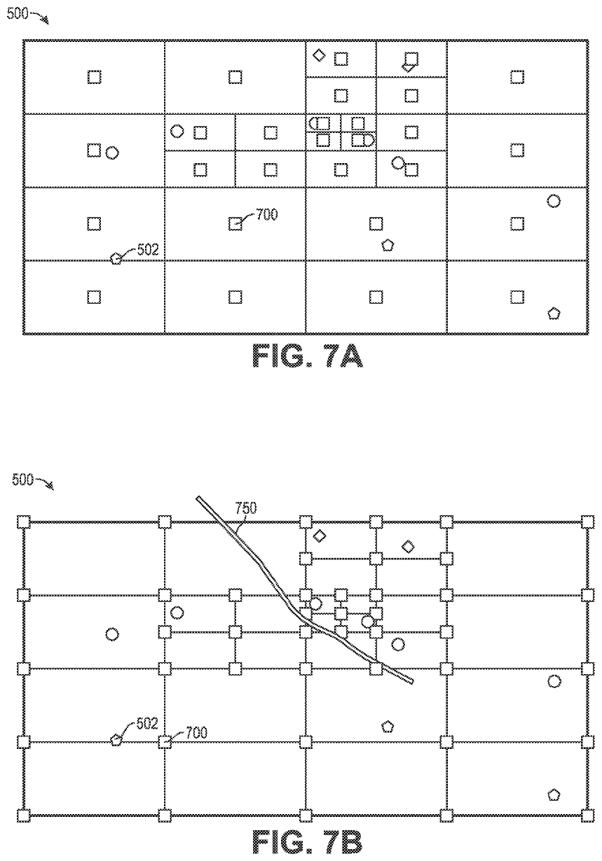

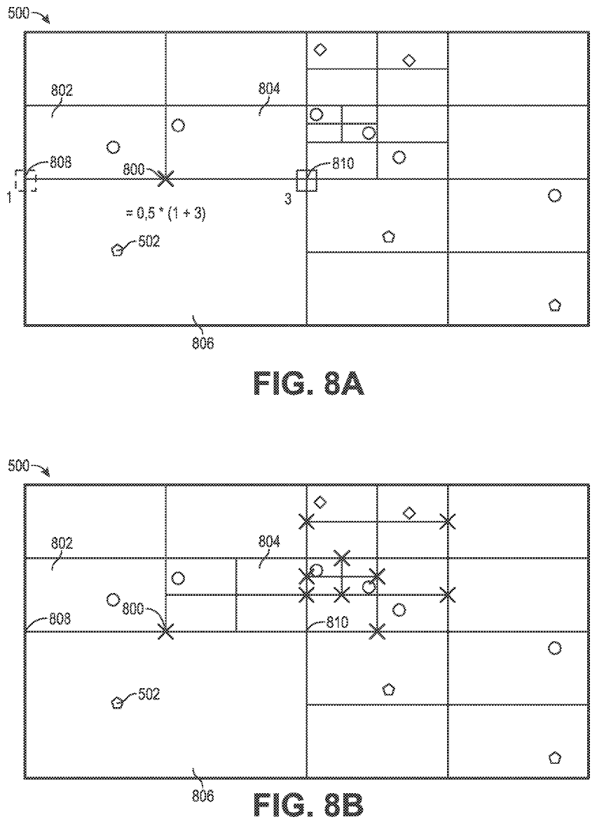

FIG. 8A illustrates an example of the subsurface volume 500 proceeding through the substitution phase, according to an embodiment. In this embodiment, the tree data structure represents nodes (e.g., points) in the subsurface volume 500, which may be separated from one another. As shown, the subsurface volume 500 includes node 800, which is shared by three, but not four, mesh elements 802, 804, 806. The mesh element 806 shares an “incomplete” or partial boundary with each of the mesh elements 802, 804. In other words, the node/corner 800 is shared by three cells 802, 804, 806, not four, which would be the maximum in a quadtree. Accordingly, this node 800 may be substituted by interpolation between two neighboring nodes 808, 810. As mentioned above, the substitution may be accomplished by averaging the two adjacent nodes 808, 810, but could be accomplished in any other manner, too. It will be appreciated that cell-center substitution may be accomplished in the same or a similar way. As a consequence of this substitution, the coefficient of the node 800 may be replaced by the interpolation function. FIG. 8B illustrates this substitution phase taken to completion in the illustrated subsurface representation, with the x's indicating corners that were substituted.

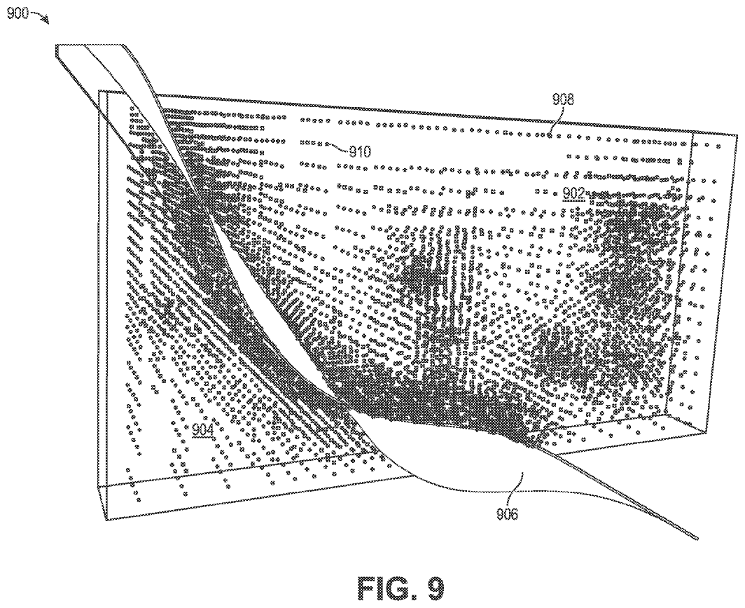

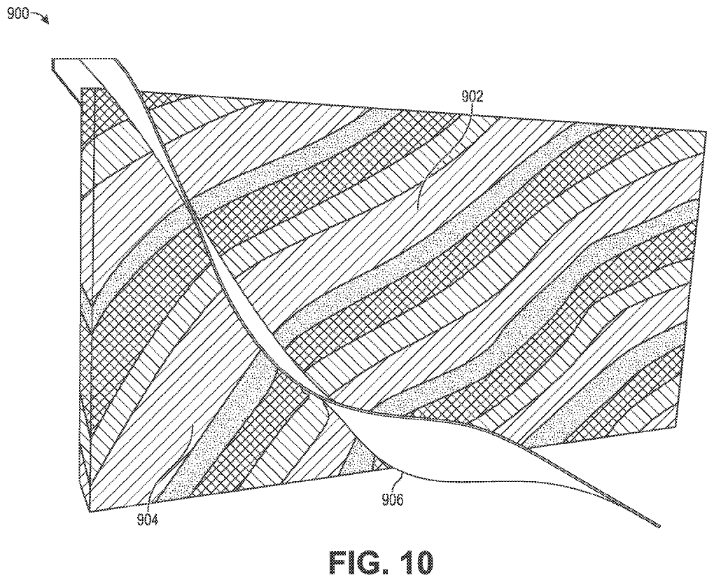

FIG. 9 illustrates a representation of the implicit function in a subsurface 900 across two domains 902, 904 separated by a fault 906. As shown, the tree data structure represents the nodes (or cell centers) as original nodes 908 and substituted nodes 910, e.g., according to the technique discussed above. FIG. 10 illustrates a visualization of the implicit function in the subsurface 900 after processing, e.g., using smoothing/regularization techniques as discussed above. For example, the implicit function may be generated as discussed above, by receiving data points having different levels of resolution in different areas, partitioning and representing the subsurface using a tree data structure, performing the substitution, and then representing the coefficients based on the constraints of the data points and the implicit function. In addition, various other processing, such as regularization, smoothing, etc., may be applied, e.g., using an approximation of bending energy with finite differences, which may be adapted to the tree being used.

The method 400 may then include simulating one or more physical processes in the subsurface volume based at least in part on the implicit function, as at 410. Such simulations may include fluid flow simulations, reservoir simulations, production modeling, etc.

In some embodiments, if the structural data points positions and structural discontinuities impose the tree to decompose into a regular grid, then the same system of equations would be solved with the additional computing time to create the tree. Further, if the results are evaluated on a regular grid of a much coarser resolution than the created tree's finest resolution, then the time taken to create the tree and to solve the associated system may equal or exceed the time taken to solve the regular grid supported system. However, the decomposition of the tree can be controlled by the expected resolution (on top of the data points positions and structural discontinuities). Therefore, the tree would not be subdivided into finer elements than called for, reducing both the time for construction and the number of unknowns to the problem (i.e., reducing the time to solve the system of equations). Moreover, if the Cartesian grid is coarser than the finest element of the constructed tree, it might mean that it is too coarse to accommodate the geological features. Creating a continuous enough implicit function to accommodate the finest features calls for finer local resolutions, and if not in the 1st case described above, embodiments of the disclosure should outperform a regular grid-based method.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

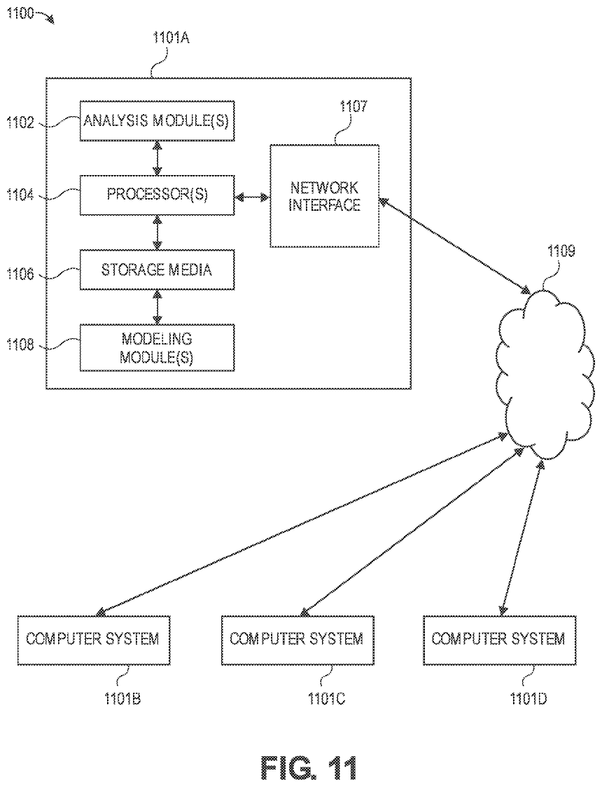

In some embodiments, any of the methods of the present disclosure may be executed by a computing system. FIG. 11 illustrates an example of such a computing system 1100, in accordance with some embodiments. The computing system 1100 may include a computer or computer system 1101A, which may be an individual computer system 1101A or an arrangement of distributed computer systems. The computer system 1101A includes one or more analysis module(s) 1102 configured to perform various tasks according to some embodiments, such as one or more methods disclosed herein. To perform these various tasks, the analysis module 1102 executes independently, or in coordination with, one or more processors 1104, which is (or are) connected to one or more storage media 1106. The processor(s) 1104 is (or are) also connected to a network interface 1107 to allow the computer system 1101A to communicate over a data network 1109 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be located in a processing facility, while in communication with one or more computer systems such as 1101C and/or 1101D that are located in one or more data centers, and/or located in varying countries on different continents).

A processor can include a microprocessor, microcontroller, processor module or subsystem, programmable integrated circuit, programmable gate array, or another control or computing device.

The storage media 1106 can be implemented as one or more computer-readable or machine-readable storage media. Note that while in the example embodiment of FIG. 11 storage media 1106 is depicted as within computer system 1101A, in some embodiments, storage media 1106 may be distributed within and/or across multiple internal and/or external enclosures of computing system 1101A and/or additional computing systems. Storage media 1106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1100 contains one or more modeling module(s) 1108. In the example of computing system 1100, computer system 1101A includes the modeling module 1108. In some embodiments, a single modeling module may be used to perform some or all aspects of one or more embodiments of the methods. In alternate embodiments, a plurality of modeling modules may be used to perform some or all aspects of methods.

It should be appreciated that computing system 1100 is only one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 11 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAS, PLDs, or other appropriate devices. These modules, combinations of these modules, and/or their combination with general hardware are all included within the scope of protection of embodiments of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1100, FIG. 11), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the embodiments of the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving data representing a subsurface volume, the data including data points representing one or more physical properties of the subsurface volume;
generating a tree data structure representing the subsurface volume, generating the tree data structure includes:
partitioning a digital representation of the subsurface volume into mesh elements based at least in part on locations of the data points of the data;
storing a location of the mesh elements in the tree data structure; and
assigning coefficients to the mesh elements, the coefficients representing one or more physical properties of the subsurface volume represented by the individual mesh elements;
determining an implicit function representing the one or more physical properties of the subsurface volume based at least in part on the assigned coefficients, wherein the implicit function is continuous across a domain; and
visualizing at least a portion of the subsurface volume based at least in part on the implicit function.

2. The method of claim 1, comprising:
separating the digital representation of the subsurface volume into two domains, including the domain, based at least in part on a presence of a structural discontinuity in the subsurface; and
determining the implicit function separately for the two domains, the implicit function is continuous in the respective domains.

3. The method of claim 1, comprising:
identifying a first mesh element of the mesh elements having a first size;
identifying a second mesh element of the mesh elements that shares at least a portion of an edge with the first mesh element, the second mesh element having a second size that is smaller than the first size; and
substituting the coefficient of the second mesh element by interpolating the assigned coefficients of two mesh elements that neighbor the second mesh element.

4. The method of claim 3, wherein the first size and the second size are represented by two different depths of two tree elements in the tree data structure, the two tree elements representing the first mesh element and the second mesh element, respectively, in the tree data structure.

5. The method of claim 4, wherein partitioning includes constraining neighboring mesh elements to a maximum of one level of the depth difference in the tree data structure.

6. The method of claim 1, wherein the tree data structure includes at least one of a binary tree, a quadtree, or an octree.

7. The method of claim 1, wherein assigning the coefficients includes applying a Heaviside step function, a finite element method, or a gradient function based on a center of the individual mesh elements.

8. The method of claim 1, comprising simulating the one or more properties of the subsurface volume over time using the implicit function.

9. A non-transitory, computer-readable medium storing instructions that, when executed by at least one processor of a computing system, cause the computing system to perform operations, the operations comprising:
receiving data representing a subsurface volume, the data including data points representing one or more physical properties of the subsurface volume;
generating a tree data structure representing the subsurface volume, generating the tree data structure includes:
partitioning a digital representation of the subsurface volume into mesh elements based at least in part on locations of the data points of the data;
storing a location of the mesh elements in the tree data structure; and
assigning coefficients to the mesh elements, the coefficients representing one or more physical properties of the subsurface volume represented by the individual mesh elements;
determining an implicit function representing the one or more physical properties of the subsurface volume based at least in part on the assigned coefficients, wherein the implicit function is continuous across a domain; and
visualizing at least a portion of the subsurface volume based at least in part on the implicit function.

10. The medium of claim 9, wherein the operations include:
separating the digital representation of the subsurface volume into two domains, including the domain, based at least in part on a presence of a structural discontinuity in the subsurface; and
determining the implicit function separately for the two domains, the implicit function is continuous in the respective domains.

11. The medium of claim 9, wherein the operations include:
identifying a first mesh element of the mesh elements having a first size;
identifying a second mesh element of the mesh elements that shares at least a portion of an edge with the first mesh element, the second mesh element having a second size that is smaller than the first size; and
substituting the coefficient of the second mesh element by interpolating the assigned coefficients of two mesh elements that neighbor the second mesh element.

12. The medium of claim 11, wherein the first size and the second size are represented by two different depths of two tree elements in the tree data structure, the two tree elements representing the first mesh element and the second mesh element, respectively, in the tree data structure.

13. The medium of claim 12, wherein partitioning includes constraining neighboring mesh elements to a maximum of one level of the depth difference in the tree data structure.

14. The medium of claim 9, wherein the tree data structure includes at least one of a binary tree, a quadtree, or an octree.

15. The medium of claim 9, wherein assigning the coefficients includes applying a Heaviside step function, a finite element method, or a gradient function based on a center of the individual mesh elements.

16. The medium of claim 9, wherein the operations include simulating the one or more properties of the subsurface volume over time using the implicit function.

17. A computing system, comprising:
one or more processors; and
a memory system including one or more non-transitory computer-readable media storing instructions that, when executed by at least one of the one or more processors, cause the computing system to perform operations, the operations including:
receiving data representing a subsurface volume, the data including data points representing one or more physical properties of the subsurface volume;
generating a tree data structure representing the subsurface volume, generating the tree data structure includes:
partitioning a digital representation of the subsurface volume into mesh elements based at least in part on locations of the data points of the data;
storing a location of the mesh elements in the tree data structure; and
assigning coefficients to the mesh elements, the coefficients representing one or more physical properties of the subsurface volume represented by the individual mesh elements;
determining an implicit function representing the one or more physical properties of the subsurface volume based at least in part on the assigned coefficients, wherein the implicit function is continuous across a domain; and
visualizing at least a portion of the subsurface volume based at least in part on the implicit function.

18. The computing system of claim 17, wherein the operations include:
separating the digital representation of the subsurface volume into two domains, including the domain, based at least in part on a presence of a structural discontinuity in the subsurface; and
determining the implicit function separately for the two domains, wherein the implicit function is continuous in the respective domains.

19. The computing system of claim 17, wherein the operations include:
identifying a first mesh element of the mesh elements having a first size;
identifying a second mesh element of the mesh elements that shares at least a portion of an edge with the first mesh element, the second mesh element having a second size that is smaller than the first size; and
substituting the coefficient of the second mesh element by interpolating the assigned coefficients of two mesh elements that neighbor the second mesh element.

20. The computing system of claim 19, wherein the first size and the second size are represented by two different depths of two tree elements in the tree data structure, the two tree elements representing the first mesh element and the second mesh element, respectively, in the tree data structure.
